(19) United States
(12) Patent Application Publication
(10) Pub. No.: US 2025/0363679 A1
(43) Pub. Date: Nov. 27, 2025

(54) Generating Improved Product Images

(71) Applicant: Google LLC, Mountain View, CA (US)

(72) Inventors: Garima Pruthi, San Jose, CA (US); Praneet Dutta, Sunnyvale, CA (US); Charles Baxter Boyd, Santa Clara, CA (US); Krista Lynn Holden, Sunnyvale, CA (US); Ishaan Malhi, Sunnyvale, CA (US); Brendan Joseph Driscoll, Allston, MA (US); Arunachalam Narayanaswamy, Sunnyvale, CA (US)

(21) Appl. No.: 19/215,020

(22) Filed: May 21, 2025

Related U.S. Application Data
(60) Provisional application No. 63/650,289, filed on May 21, 2024.

(51) Int. Cl. G06T 11/00; G06F 40/40; G06T 3/40; G06T 3/60; G06T 13/00; G06T 15/20

(52) U.S. Cl. CPC G06T 11/00; G06T 3/40; G06T 3/60; G06T 13/00; G06T 15/20; G06F 40/40

(57) ABSTRACT

An image generation method is performed by one or more data processing apparatus, and comprises: obtaining an image showing an object; generating one or more additional images related to the object; fine-tuning a machine-learned text-to-image model using one or more of the additional images; providing, to the machine-learned text-to-image model, a prompt to generate an output image showing the object, and obtaining, from the machine-learned text-to-image generation model, the output image.

### RELATED APPLICATIONS

This application claims priority to and the benefit of U.S. Provisional Patent Application No. 63/650,289, filed May 21, 2024. U.S. Provisional Patent Application No. 63/650,289 is hereby incorporated by reference in its entirety.

### FIELD

This specification relates to an image generation method for generating images that depict one or more objects. It also relates to a system for performing the method, and an associated computer-readable storage medium.

### BACKGROUND

The development of text-to-image generation models has enabled images to be generated by simply inputting an appropriate text prompt to the model. For example, an appropriate prompt may be provided to generate an image showing a particular object in use and/or with a suitable background. However, existing text-to-image generation systems may be limited in their ability to show a particular object in an appropriate context (e.g. illustrating its use) whilst also producing a high-quality image which is faithful to the appearance of the object.

### SUMMARY

According to a first aspect, there is provided an image generation method for generating improved object images. The method is performed by one or more data processing apparatus, and comprises obtaining an image showing an object. One or more additional images related to the object are generated. A machine-learned text-to-image generation model is fine-tuned using one or more of the additional images. A prompt is provided to the fine-tuned machine-learned text-to-image model so as to generate an output image showing the object. Generating the one or more additional images may comprise processing the image using one or more generative models.

In some examples, one or more of the additional images may show the object from a different perspective compared to the image, for example from a different angle compared to the image or at a different zoom level compared to the image. Generating such an additional image may comprise: generating, using a machine-learned text-to-video model, a video showing the object, the video showing the object being rotated and/or zoomed in or out, and extracting one or more of the additional images from the video. In some examples, the machine-learned text-to-video model may be provided with a conditioning input defining the first frame of the video, the conditioning input comprising the image showing the object.

As another example, generating one or more additional images related to the object may comprise: inputting the image showing the object to a machine-learned 3D reconstruction model, and generating one or more of the additional images based on an output of the machine-learned 3D reconstruction model.

In some examples, at least one of the additional images shows the object in a different context compared to the image, for example by showing the object against a different background compared to the image.

In some examples, at least one of the additional images shows a different object of a same object type as the object shown in the image.

The image may show the object together with one or more image elements, and the method may comprise generating an additional image without at least one of the one or more image elements.

In some examples, generating the one or more additional images may comprise: generating a prompt comprising an instruction to modify the image; providing the prompt to a machine learning model configured for image modification, and obtaining one or more of the additional images as an output of the machine learning model.

In some examples, one or more of the additional images may be selected for fine-tuning the machine-learned text-to image model based on one or more respective quality scores for the one or more additional images.

The method may further comprise generating the prompt. Generating the prompt may comprise: receiving, at a machine-learned generative language model, an input comprising an instruction to generate the prompt, and generating the prompt as an output of the machine-learned generative language model.

Receiving, at the machine-learned generative language model, an input, may comprise receiving contextual information relating to the object. Receiving, at the machine-learned generative language model, an input, may comprise receiving a description of the object.

In some examples, the machine-learned generative language model may comprise a multimodal model, and receiving, at the machine-learned generative model, an input, may comprise receiving the image showing the object, or another image showing the object.

In some examples, the method comprises obtaining one or more images showing a plurality of related objects.

According to a second aspect, there is a provided a non-transitory computer-readable storage medium comprising instructions that when executed by one or more data processing apparatus cause the one or more data processing apparatus to carry out a method according to the first aspect.

According to a third aspect, there is provided a system comprising one or more data processing apparatus, and one or more memories storing instructions that when executed by the one or more data processing apparatus cause the one or more data processing apparatus to carry out a method according to the first aspect.

The techniques described in this specification provide improvements to image generation systems. For example, by fine-tuning a text-to-image generation model using additional images showing an object from different perspectives, the model is provided with additional spatial context regarding the 3D structure of the object. This improves the ability of the model to generate synthetic images of the object, for example in different contexts (e.g. from different viewpoints) whilst also providing a high-quality image which is faithful to the appearance of the object. Techniques described in this specification also permit the generation of high-fidelity object images showing a number of related objects, since the model is better able to understand the spatial relationship of the related objects to one another (e.g. the relative position of table and chairs). Moreover, techniques described in this specification advantageously provide for changes to the illumination of the foreground, as well as appropriate occlusion of the object in the foreground, which are not generally possible with existing background replacement techniques.

In some examples, the object is a product. In this case, the image may for example, be obtained from a product feed, and may be referred to as a product image or, more specifically, as an input product image. The output image may be a product image which recontextualises the input product image based on the prompt. For instance, the output image may show the product in an appropriate product context, for example illustrating its use and/or with a suitable background. Compared to existing techniques, various example implementations described in this specification leverage additional images to provide improved product recontextualization e.g., through improved illumination, appropriate occlusion of the foreground/product, higher quality product images (e.g., improved resolution), improved faithfulness to the appearance of the product, and alternative viewpoints/perspectives. In some examples, images showing multiple related products may be generated, e.g., images showing a number of related products (e.g., a set of furniture items) in the same context.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of a system for generating improved object images according to an example implementation.

FIG. 2 is a schematic illustration of a system for generating improved object images according to a particular example;

FIG. 3 is a schematic illustration of a system for generating improved object images according to another particular example;

FIG. 4 is a schematic illustration of a system for generating improved object images according to another example implementation, and

FIG. 5 is a flow diagram illustrating an image generation method for generating improved object images in accordance with an example implementation.

Like reference numbers and designations in the various drawings denote like elements.

### DETAILED DESCRIPTION

Generally, the present disclosure is directed to generating improved (e.g. enhanced) images that depict one or more objects. In some examples, the object is a commercial product, and the generated image is a product image. In other examples, the object may be an object other than a product. For example, techniques described in this specification may be used to generate improved synthetic images showing e.g., venues, landmarks or other points of interest, food items etc.

In one example, an input image (or a set of images) showing a particular product is obtained, for instance from an e-commerce product feed. One or more additional images related to the product are generated using the input image(s), for example by using one or more machine-learning models (e.g. one or more generative models) to generate images showing the product from different perspectives (e.g. different angles) and/or different contexts (e.g. different backgrounds) compared to the input image(s), and/or by generating “negative” or “counterfactual” images, as described below. The additional images are used to fine-tune a machine-learned text-to-image model, which is in turn used to generate an output product image responsive to an input prompt. In this way, output product images may be generated which are improved compared to the input product image(s). For example, the output product image may show the product in an appropriate context (e.g. illustrating its use and/or with an appropriate background) whilst also producing an image which is faithful to the appearance of the product and/or higher quality (e.g. improved resolution) compared to the input image(s).

In another example, the input image is a product image showing a number of products, for example a number of related products which together form a set (e.g. a set of furniture). Thus, the term “product image” as used herein, is an image showing either a single product or a number of products which may be related to one another. More generally, the term “object image” as used herein, is an image showing either a single object, or a number of objects which may be related to one another.

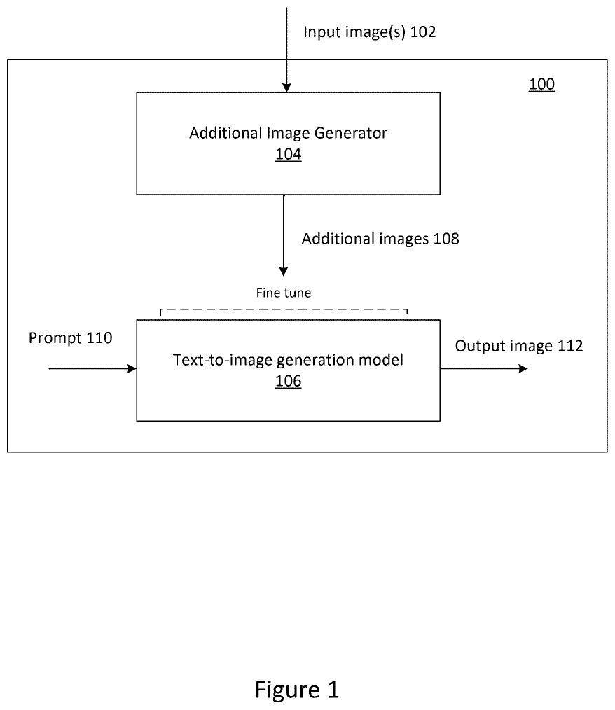

FIG. 1 is a schematic illustration of a system 100 for generating improved object images according to an example implementation. As shown, the system 100 receives one or more input images 102 which depict at least one object. For example, the object may comprise a product, and the image(s) may comprise product image(s) for the product.

As shown, the system 100 includes an additional image generator 104 and a machine-learned text-to-image generation model 106. The additional image generator 104 is configured to process the input image(s) 102 so as to generate one or more additional images 108 which relate to the object(s) shown in the input image(s). The system 100 is configured to fine-tune the machine-learned text-to-image generation model 106 using at least the one or more of the additional images. In some examples, the input image(s) 102 may also be used to fine-tune the machine-learned text-to-image generation model 106.

The machine-learned text-to-image model 106 may comprise a subject-driven text-to-image generation model such as Dreambooth, described in “DreamBooth: Fine Tuning Text-to-Image Diffusion Models for Subject-Driven Generation”, Nataniel Ruiz et al, arXiv: 2208.12242 [cs.CV], which is hereby incorporated by reference in its entirety, or SuTi, described in “Subject-driven Text-to-Image Generation via Apprenticeship Learning”, Wenhu Chen et al, arXiv: 2304.00186 [cs.CV], which is hereby incorporated by reference in its entirety, or a model which is capable of subject-driven text-to image generation such as Instruct-Imagen, described in “Instruct-Imagen: Image Generation with Multi-modal Instruction”, Heixiang Hu et al, arXiv: 2401.01952 [cs.CV]), which is hereby incorporated by reference in its entirety.

As described in “DreamBooth: Fine Tuning Text-to-Image Diffusion Models for Subject-Driven Generation”, the DreamBooth model, for example, may be fine-tuned using one or more images of a subject. In this way, an object (e.g., product) can be implanted into the output domain of the model such that it can be synthesized in inference by including a unique identifier in the text prompt. Other subject-driven text-to-image generation models (or models which are capable of subject-driven text-to-image generation) may be fine-tuned in a similar way.

Thus, given a set of additional images generated for a particular object, the text-to-image generation model 106 may be fine-tuned using the additional images. Optionally, the input image(s) may also be used for fine-tuning. The set of images used to fine-tune the text-to-image generation model may be referred to herein as a set of training images.

Once it has been fine-tuned in this way, the text-to-image generation model 106 can produce improved images 112 responsive to input prompts 110, i.e. images which are enhanced with respect to images that would be produced by a text-to-image generation model which has not been fine-tuned according to the techniques described in this specification.

Although FIG. 1 illustrates the processing of a single set of input image(s) 102, it will be understood that more generally, the system 100 may process a stream of input images comprising different sets of images for different objects, e.g., a stream of product images from an e-commerce product feed. For each set of input image(s) showing a particular object, a corresponding prompt may be provided to the machine-learned text-to-image generation model 106 so as to generate a respective enhanced output image showing the object.

In some cases, the parameters (e.g. weights) of the machine-learned text-to-image generation model 106 may be fine-tuned with a dataset of selected images (which may further comprise image captions for each of the selected images) prior to fine-tuning the model with the additional images. In the case of product images, the dataset may for example comprise high-performing image media assets annotated with tokens on areas such as product category, region, audience, and advertising channel.

Advantageously, the additional images may show the object (e.g., product) from a different perspective, e.g. at a different angle and/or at a different zoom level compared to the input image. In this way, the text-to-image generation model 106 is provided with additional spatial context regarding the 3D structure of the object. This has been found to improve the performance of the text-to-image generation model when generating images of the object in a contextual setting (e.g. a setting illustrating the use of a product).

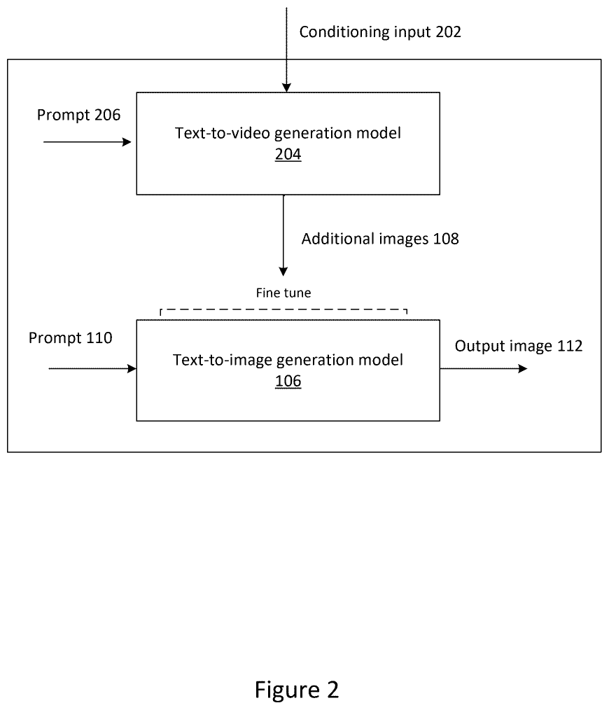

In the example of FIG. 2, the additional image generator 104 comprises a text-to-video generation model 204 configured to receive a conditioning input 202 and a prompt 206. The text-to-video generation model 204 may be used to generate one or more additional images showing the object (e.g., product) from a different perspective. For example, the text-to-video generation model 204 may comprise the Lumiere model, described in the paper “Lumiere: A Space-Time Diffusion Model for Video Generation”, Omer Bar-Tal et al, arXiv: 2401.12945 [cs.CV], which is hereby incorporated by reference in its entirely. As discussed in this paper, text-to-video generation models such as Lumiere can be provided with one or more conditioning inputs (e.g. one or more frames). Thus, the text-to-video generation model may be provided with a conditioning input 202 comprising the input image as the first frame of the video to be generated. In an example, the text-to-video generation model 204 may be further provided with a text prompt 206 to generate a video in which the object rotates or in which the video pans across the object. Frames may then be extracted from the generated video (e.g. after certain predetermined portions of the video has elapsed) to obtain images showing the object from different angles and/or in different locations within the image. The extracted frames may be used as additional images 108 for fine-tuning the text-to-image generation model 106.

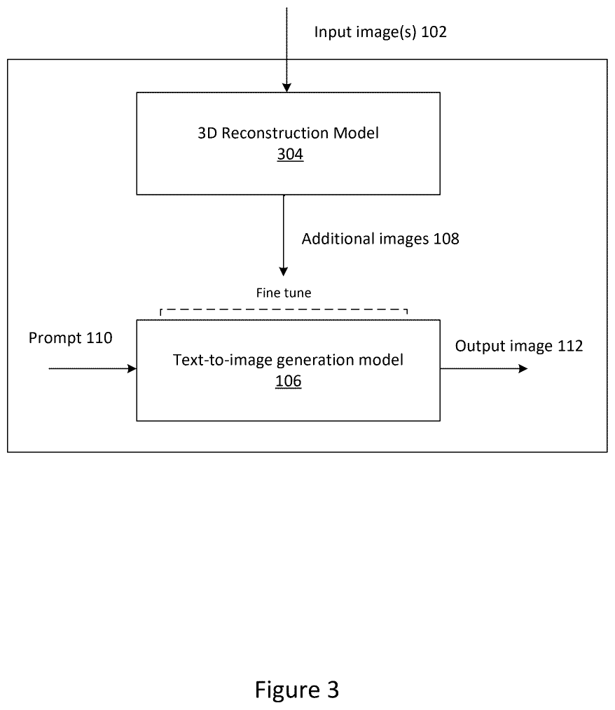

Alternatively, or in addition, one or more of the additional images may be generated using a 3D reconstruction model, such as LRM, described in the paper “LRM: Large Reconstruction Model for Single Image to 3D”, Yicong Hong et at, arXiv: 2311.04400 [cs.CV], which is hereby incorporated by reference in its entirety. Such a model may be used to predict a neural radiance field (NeRF) for the object (e.g., product) based on the input image 102. The generated NeRF or other 3D model may then be used to extract 2D images showing the object from different perspectives (e.g. at different angles and/or zoom levels). FIG. 3 shows an example in which the additional image generator 104 comprises a 3D Reconstruction Model 304 configured to process the input image 102 to generate a 3D model from which additional images 108 may be extracted.

Alternatively, or in addition, one or more of the additional images may be generated by replacing the background of an input image with another background. For example, a machine-learned segmentation model (e.g. a semantic segmentation model) may be used to segment an input image into a foreground image showing the object (e.g., product), and a background image. For example, an input image showing a product (e.g. a car) with a white background may be modified by replacing the white background with a background showing the product in an appropriate context (e.g. on road).

Alternatively, in or addition, one or more of the additional images may be generated using an “editable” model, i.e. a model which has masking, inpainting, and/or outpainting capability.

In some examples, the additional image generator 104 itself comprises a text-to-image generation model (e.g. a subject driven image generation model such as Dreambooth), which may be fine-tuned on a set of one or more images depicting the object (e.g., product). Thus, in some implementations, the additional image generator 104 may be provided with one or more prompts to generate the additional images directly. For example, the additional image generator 104 may be prompted to generate additional image(s) showing the object from a different perspective (e.g. different angle and/or different zoom level) and/or a different context (e.g. with a different background and/or illustrating a product in use).

In some implementations, the additional image generator 104 may be used (e.g., prompted) to generate one or more additional images showing a different object to the object shown in the input image(s), but of the same object type, e.g., a different product of the same product type. Including such “negative” images for fine-tuning the machine-learned text-to-image generation model 106 can help the model 106 to understand an object by seeing examples of what the object is not.

Alternatively, or in addition, the additional image generator 104 may be used (e.g., prompted) to generate one or more additional images showing the object (e.g. product) with or without one or more image elements that it is typically associated with. The presence of such “counterfactual” images in the training set can help the machine-learned text-to-image model 106 to disentangle the specific object from image elements that it is usually associated with. For example, images of earrings may typically also show a face, while images of a lamp may typically also show a bulb.

In some cases, automated prompt generation techniques may be used to generate prompt(s) for the additional image generator 104. For example, a language model (e.g. large language model) may be prompted to generate a set of prompts for the additional image generator 104 to generate a suitable set of training images which maximises the diversity of images, to help the machine-learned text-to-image model best understand what the object (e.g., product) is, and what it is not.

In some examples, the additional images may be filtered before they are used to fine-tune the machine-learned text-to-image model. For example, a quality model may be used to process the additional images to generate a score. Additional images in which the score does not meet a certain threshold may be rejected and so not used for fine-tuning. The quality model may be an image plausibility or image attractiveness model, or may be a model which evaluates product fidelity, background fidelity and/or other quality metrics.

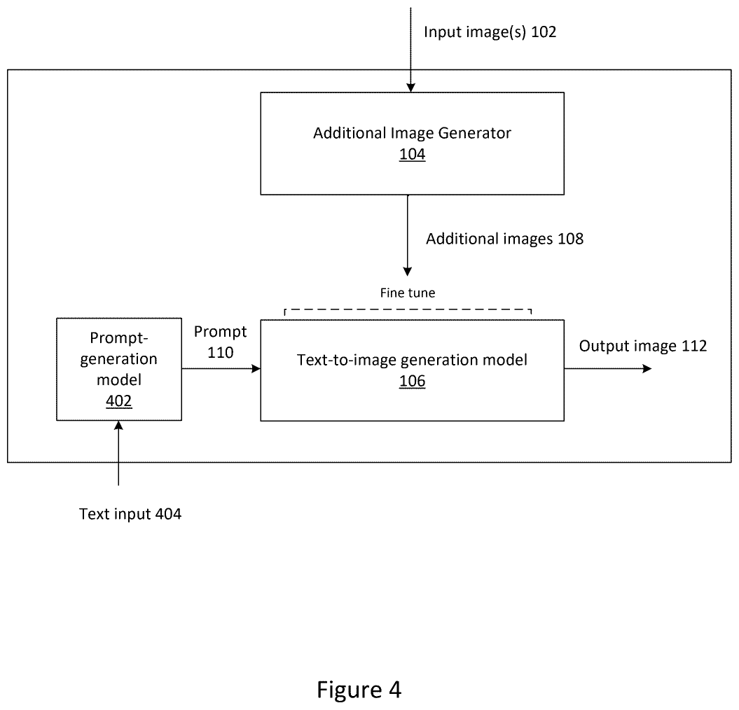

The fine-tuned machine-learned text-to-image model 106 may be used to generate improved object images based on received prompts. In some examples, the prompt may comprise a simple instruction to generate a contextual image of the object and/or to generate a high-quality object image. In other examples, the prompt may be generated using a prompt-generation model, which may comprise a text-to-text language model (e.g. a large language model, LLM). FIG. 4 illustrates an example in which a prompt-generation model 402 is used to generate the prompt 110 based on received text input 404.

As a particular example, the prompt-generation model 402 can be an auto-regressive Transformer-based neural network that includes (i) a plurality of attention blocks, at least some of which apply a self-attention operation and (ii) an output subnetwork that processes an output of the last attention block to generate the score distribution. The prompt-generation model 402 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020, all of which are hereby incorporated by reference in their entirety.

In some examples, the prompt-generation model 402 may be primed with image captions from a large set of high-performing image media assets, with token annotations in areas such as product category, region, audience or advertising channel. This allows the prompt generation model 402 to learn what content is likely to work well in the different areas.

In some examples, it may be desirable for the prompt-generation model 402 to generate a prompt for producing images to fill identified visual creative gaps in the performance of an ongoing communication campaign, to boost performance of the campaign. This may be achieved by providing an appropriate input prompt to the prompt-generation model 402, i.e. an input prompt which includes instructions to generate a prompt for the machine-learned text-to-image model to produce such an image.

In some examples, a template input prompt for the prompt-generation model 402 may be used to provide template instructions to generate a suitable input prompt instructing the machine-learned text-to-image model to generate an image. In examples in which the object depicted in the input image is a product, the template may be populated with information relating to the product, for example the product name, product type, product description and/or other information relating to the product. In some cases, the template may also include examples of suitable prompts for other products.

The populated template may then be provided as input to the prompt-generation model to generate one or more prompts for the fine-tuned machine-learned text-to-image model. The one or more generated prompts may then be provided as input to the fine-tuned machine-learned text-to-image model so as to generate output image(s).

In some examples, the prompt-generation model 402 may comprise a multimodal model, which may receive one or more of the input image(s), in addition to a text prompt.

In accordance with various examples implementations described in this specification, synthetic object images (e.g. product images) may be generated which recontextualise and improve the input object images. The generated images may show the object in an appropriate context (e.g. illustrating its use and/or with a suitable background) whilst also producing an image which is faithful to the appearance of the object and/or higher quality (e.g. improved resolution) compared to the input image(s). Compared to existing techniques (e.g. existing techniques based on background replacement), the techniques described in this specification provide for changes to the illumination of the foreground, appropriate occlusion of the foreground/object, and also alternative viewpoints/perspectives. The capability to understand and show alternative viewpoints/perspectives also allows the described techniques to recontextualise object images which show multiple objects (e.g. a set of furniture), e.g., to generate images showing multiple products in the same context.

Although the techniques described in this specification may be used to generate product images, in some examples they may also be used to images showing other types of objects. For example, techniques described in this specification may be used to generate improved synthetic images showing e.g., venues, landmarks or other points of interest, food items etc.

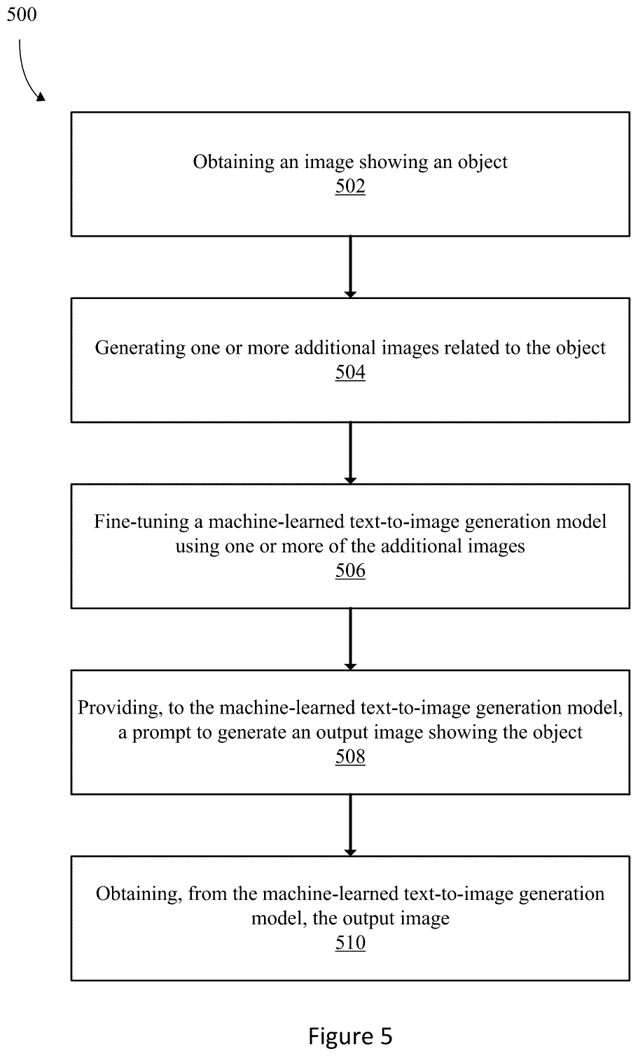

FIG. 5 is a flow diagram illustrating an example image generation method 500 for generating improved object images (e.g., product images). As shown, the method includes obtaining 502 an image showing an object (e.g., a product). The method further includes generating 504 one or more additional images related to the object. In some examples, one or more of the additional images may show the object from a different perspective compared to the image, at a different angle compared to the image, or at a different zoom level compared to the image. Alternatively, or in addition, one or more of the additional images may show the object in a different context compared to the image, or against a different background compared to the image. Alternatively, or in addition, one or more of the additional images may show a different object (e.g., different product) of a same object type (e.g., same product type) as the object shown in the image.

The method 500 further comprises fine-tuning 506 a machine-learned text-to-image generation model using one or more of the additional images. In some examples, the machine-learned text-to-image generation model comprises a subject-driven model.

The method 500 further comprises providing 508, to the machine-learned text-to-image generation model, a prompt to generate an output image showing the object, and obtaining 510, from the machine-learned text-to-image generation model, the output image.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

As used herein, the term data processing apparatus includes any suitable computing device or hardware for use in performing the methods described in this specification. The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. An image generation method performed by one or more data processing apparatus, comprising:
obtaining an image showing an object;
generating one or more additional images related to the object;
fine-tuning a machine-learned text-to-image generation model using one or more of the additional images;
providing, to the machine-learned text-to-image generation model, a prompt to generate an output image showing the object, and
obtaining, from the machine-learned text-to-image generation model, the output image.

2. The method of claim 1, wherein generating the one or more additional images comprises processing the image using one or more generative models.

3. The method of claim 1, wherein at least one of the additional images shows the object from a different perspective compared to the image.

4. The method of claim 3, wherein at least one of the additional images shows the object at a different angle compared to the image.

5. The method of claim 3, wherein at least one of the additional images shows the object at a different zoom level compared to the image.

6. The method of claim 3 wherein generating the least one of the additional images comprises:
generating, using a machine-learned text-to-video model, a video showing the object, the video showing the object being rotated and/or zoomed in or out, and
extracting one or more of the additional images from the video.

7. The method of claim 6, comprising providing the machine-learned text-to-video model with a conditioning input defining the first frame of the video, the conditioning input comprising the image showing the object.

8. The method of claim 3, wherein generating one or more additional images related to the object comprises:
inputting the image showing the object to a machine-learned 3D reconstruction model, and
generating one or more of the additional images based on an output of the machine-learned 3D reconstruction model.

9. The method of claim 8, wherein the 3D reconstruction model is configured to predict a neural radiance field for the object.

10. The method of claim 1, wherein at least one of the additional images shows the object in a different context compared to the image.

11. The method of claim 10, wherein at least one of the additional images shows the object against a different background compared to the image.

12. The method of claim 1, wherein at least one of the additional images shows a different object of a same object type as the object shown in the image.

13. The method of claim 1, wherein the image shows the object and one or more image elements, and wherein at least one of the additional images shows the object without at least one of the one or more image elements.

14. The method of claim 1, comprising selecting one or more of the additional images for fine-tuning the machine-learned text-to image model based on one or more respective quality scores for the one or more additional images.

15. The method of claim 1, further comprising generating the prompt, wherein generating the prompt comprises:
receiving, at a machine-learned generative language model, an input comprising an instruction to generate the prompt, and
generating the prompt as an output of the machine-learned generative language model.

16. The method of claim 15, wherein the machine-learned generative language model is a multimodal model, and wherein receiving, at the machine-learned generative language model, an input, comprises receiving an image showing the object, another image showing the object.

17. One or more non-transitory computer-readable media storing instructions that are executable by one or more data processing apparatus to cause the one or more data processing apparatus to perform a method comprising:
obtaining an image showing an object;
generating one or more additional images related to the object;
fine-tuning a machine-learned text-to-image generation model using one or more of the additional images;
providing, to the machine-learned text-to-image generation model, a prompt to generate an output image showing the object, and
obtaining, from the machine-learned text-to-image generation model, the output image.

18. The one or more non-transitory computer-readable media system of claim 17, wherein at least one of the additional images shows the object from a different perspective compared to the image.

19. The one or more non-transitory computer-readable media of claim 18, wherein generating the least one of the additional images comprises:
generating, using a machine-learned text-to-video model, a video showing the object, the video showing the object being rotated and/or zoomed in or out, and
extracting one or more of the additional images from the video.

20. A system comprising:
one or more data processing apparatus; and
one or more memories storing instructions that when executed by the one or more data processing apparatus cause the one or more data processing apparatus to carry out a method comprising:
obtaining an image showing an object;
generating one or more additional images related to the object;
fine-tuning a machine-learned text-to-image generation model using one or more of the additional images;
providing, to the machine-learned text-to-image generation model, a prompt to generate an output image showing the object, and
obtaining, from the machine-learned text-to-image generation model, the output image.
